(19) United States
(12) Patent Application Publication
(10) Pub. No.: US 2011/0118113 A1
(43) Pub. Date: May 19, 2011

(54) EXHAUST GAS PURIFYING CATALYST

(76) Inventors: Naoto Miyoshi, Aichi-ken (JP); Yoshiteru Yazawa, Aichi-ken (JP); Kunio Ezaki, Aichi-ken (JP); Hiroto Imai, Shizuoka-ken (JP)

(21) Appl. No.: 12/674,956

(22) PCT Filed: Aug. 27, 2008
(86) PCT No.: PCT/JP2008/065801

§ 371 Date: Feb. 24, 2010

(30) Foreign Application Priority Data
Aug. 27, 2007 (JP) 2007-219789

(51) Int. Cl. B01J 21/06

(52) U.S. Cl. 502/304

(57) ABSTRACT

Disclosed is an exhaust gas purifying catalyst, including Rh/Y—ZrO₂ particles obtained by supporting Rh on zirconia support particles which contain yttria, wherein yttria is contained in an amount of 2˜9 mol % in the support particles. The exhaust gas purifying catalyst exhibits a superior high-temperature durability because the zirconia support can resist heat, thereby particularly increasing the structure retaining power and the thermal stability of Rh.

### BACKGROUND OF THE INVENTION

1. Field of the Invention

The present invention relates to an exhaust gas purifying catalyst, which is capable of efficiently purifying harmful components from automobile exhaust gases, and more particularly, to an exhaust gas purifying catalyst, which can prevent the deterioration of Rh.

2. Description of the Related Art

As an exhaust gas purifying catalyst for lean-burn engines, a NOx storage reduction type catalyst including a noble metal and a NOx storage material has been used. Such a NOx storage reduction type catalyst functions to store NOx in the NOx storage material in a lean atmosphere so as to reduce and purify NOx released from the NOx storage material upon rich spike, using a reducing component, such as HC, which is abundantly present in the atmosphere.

The NOx storage reduction type catalyst typically includes Pt and Rh supported thereon. Pt, having excellent oxidation activity, functions to oxidize and purify HC and CO, and further, acts that NO is oxidized into NO₂ which is then stored in the NOx storage material. Also, Rh plays a role in reducing NOx and separating sulfur oxides from the NOx storage material which is poisoned and thus deteriorated by sulfur oxides.

That is, Rh is responsible for producing hydrogen having a high reducing power from HC and H₂O in exhaust gases (the steam reforming reaction), and such hydrogen greatly contributes to the reduction of NOx and the separation of SOx from sulfate or sulfite of the NOx storage material. Thus, upon rich pulse, the amount of NOx that is reduced is high, and the extent of sulfur poisoning is remarkably decreased.

However, the NOx storage reduction type catalyst is used in a special atmosphere in which the lean atmosphere and the rich atmosphere are alternated repeatedly, and also, oxidation and reduction reactions occur frequently on the surface of the catalyst, undesirably greatly facilitating thermal deterioration due to the noble metals supported on the catalyst. The thermal deterioration is known to be caused by the alloying of Pt and Rh or the grain growth of Pt or Rh.

An example of the support on which Rh is supported includes zirconia, which increases the steam reforming activity of Rh. However, zirconia has lower heat resistance than aluminum oxide which is mainly used as the support of noble metal. When such zirconia is used as an exhaust gas purifying catalyst, the specific surface area thereof is decreased due to heat, thereby decreasing the dispersibility of Rh which is supported thereon, resulting in a lowered purification performance.

Further, the extent of the increase in steam reforming activity of Rh by zirconia is not sufficient, and therefore, the development of a support for further increasing the steam reforming activity of Rh is required.

Japanese Unexamined Patent Application Publication No. Hei. 11-226404 discloses an exhaust gas purifying catalyst comprising first powder, obtained by supporting Pt and a NOx storage material on a first support composed of porous particles, and second powder obtained by supporting Rh on a second support composed of zirconia stabilized by at least one alkali earth metal or rare earth metal.

In this way, when Pt and Rh are separately supported on different support particles, the alloying therebetween can be suppressed. Further, Rh is supported on zirconia particles stabilized by an alkali earth metal or rare earth metal, whereby NOx can be more efficiently reduced by a hydrogen resulting from a steam reforming reaction. Moreover, because the support itself is thermally stabilized, Rh can be stably supported, thus further suppressing the grain growth of Rh.

Also, Japanese Unexamined Patent Application Publication No. 2000-070717 discloses an exhaust gas purifying catalyst obtained by supporting a NOx storage material and a noble metal on a catalyst support comprising core particles, the surface of which has a coating layer which is formed of zirconia stabilized by an alkali earth metal or rare earth metal. This catalyst is advantageous because the coating layer is less liable to react with the NOx storage material, thus enhancing high-temperature durability.

Although zirconia stabilized by the alkali earth metal or rare earth metal somewhat contributes to the stabilization of Rh, the contribution thereto is not significant, and thus, there is a need to develop a support which is excellent in thermal stabilization of Rh (in particular, grain growth after the durability test is suppressed).

### SUMMARY OF THE INVENTION

Therefore, the present invention has been made in view of the above-mentioned problems, and an object of the present invention is to provide an exhaust gas purifying catalyst, which is capable of further increasing thermal stability of Rh, thus realizing a superior high-temperature durability.

According to an embodiment of the present invention, an exhaust gas purifying catalyst may comprise Rh/Y—ZrO₂ particles obtained by supporting Rh on zirconia support particles containing yttria, in which yttria is contained in an amount of 2˜9 mol % in the support particles.

In addition, according to another embodiment of the present invention, an exhaust gas purifying catalyst may comprise Rh/Y—ZrO₂ particles obtained by supporting Rh on zirconia support particles containing 2˜9 mol % of yttria and particles obtained by supporting platinum and a NOx storage material on porous oxide particles.

In the exhaust gas purifying catalyst according to the embodiments of the present invention, yttria is preferably contained in an amount of 3-8 mol % in the support particles.

### ADVANTAGEOUS EFFECTS

According to the present invention, the exhaust gas purifying catalyst is formed such that Rh is supported on zirconia support particles containing 2˜9 mol % of yttria. The support particles are characterized in that Y is a solid solution in zirconia or yttria is present in the form of fine particles, and thus the zirconia support can resist heat and has an increased ability to retain its structure, and the thermal stability of Rh is particularly increased thereby. Hence, the deterioration of Rh is suppressed, and accordingly, the exhaust gas purifying catalyst of the present invention exhibits a superior high-temperature durability.

### BRIEF DESCRIPTION OF THE DRAWINGS

The above and other objects and features of the present invention will become apparent from the following description of a preferred embodiment, given in conjunction with the accompanying drawings, in which:

FIG. 1 is a graph showing the CO adsorption capacity;

FIG. 2 is a schematic view showing the exhaust gas purifying catalyst according to the present invention;

FIG. 3 is a graph showing the amount of yttria versus the HC 50% purification temperature; and

FIG. 4 is a graph showing the catalyst inflow gas temperature versus the NOx purification rate.

### DESCRIPTION OF THE REFERENCE NUMERALS IN THE DRAWINGS

1: honeycomb substrate,
2: catalytic coating layer,
20: Y-stabilized zirconia particles,
21: porous oxide particles

### DETAILED DESCRIPTION OF THE PREFERRED EMBODIMENTS

Various embodiments of the present invention will now be described in detail with reference to the accompanying drawings. The exhaust gas purifying catalyst according to the present invention includes Rh/Y—ZrO₂ particles obtained by supporting Rh on zirconia support particles containing 2˜9 mol % of yttria. The support particles are alkaline due to the presence of yttria and thus exhibit high steam (H₂O) adsorption capability. Hence, the steam reforming reaction of Rh sufficiently progresses, thus producing hydrogen (H₂), which facilitates the reduction of NOx and the separation of SOx from the sulfate or sulfite of the NOx storage material.

Further, the use of such support particles particularly increases heat resistance, and thus a high dispersion state of Rh is maintained. Accordingly, the progression of the steam reforming reaction of Rh is better facilitated, thus further suppressing sulfur poisoning of the NOx storage material. Also, Rh which is supported on the support particles is increased in thermal stability, and thermal deterioration is suppressed in high-temperature durability tests. For these reasons, in the presence of the exhaust gas purifying catalyst of the present invention, high purification performance can be obtained even after a durability test.

In the case where the amount of yttria which is contained in the support particles is less than 2 mol % or exceeds 9 mol %, the thermal stability of zirconia is decreased. Thus, the thermal stability of Rh supported on the support particles is also decreased, and catalytic performance is lowered owing to the deterioration thereof. Preferably, the amount of yttria that is contained in the support particles is set at 3˜8 mol %, and more preferably at 4˜6 mol %.

The yttria-stabilized support particles are prepared through a co-precipitation process or a sol-gel process. In the co-precipitation process, a zirconium compound and an yttrium (Y) compound precipitate together in a solution in which the zirconium compound and the yttrium (Y) compound are dissolved, and the resultant precipitate is washed, dried, and burned, thereby obtaining support particles. Alternatively, in the sol-gel process, a solution mixture comprising zirconium alkoxide and yttrium (Y) alkoxide is added with water to hydrolyze the mixture, after which the resultant sol is dried and burned, thereby obtaining support particles.

In the support particles thus obtained, only the peak of zirconia is observed by X-ray diffraction, and the peak resulting from yttria is not observed. From this, yttria is estimated to exist in a solid solution in zirconia. In addition, the process of preparing the support particles is not limited to the above examples, and includes for example powder mixing and burning or others, and yttria may not be necessarily dissolved in a solid solution in zirconia.

The amount of Rh that is supported on the support particles is preferably set to 0.1˜10 g per liter of the catalyst. When the amount of Rh supported is smaller than 0.1 g, the purification performance becomes inadequate. Conversely, when the amount exceeds 10 g, the purification performance reaches saturation levels and the cost is increased.

The exhaust gas purifying catalyst according to the present invention may be used in the form of a three-way catalyst or NOx storage reduction type catalyst. To this end, a noble metal having a high activity of oxidation, such as Pt or Pd, should be further supported. In this case, the noble metal which is not Rh is preferably supported on different porous oxide particles, thereby suppressing the alloying thereof with Rh and avoiding adverse effects due to co-existence with Rh, leading to a more increased durability.

Examples of the porous oxide particles for supporting the noble metal which is not Rh include aluminum oxide, zirconia, cerium oxide, and titanium oxide, which may be used alone or in combinations thereof. The metal, such as Pt, is preferably supported in an amount of 0.1˜10 g per liter of the catalyst. When the supported amount of metal such as Pt is smaller than 0.1 g, the purification performance becomes inadequate. Conversely, when the supported amount is greater than 10 g, the purification performance becomes saturated and the cost is increased. Further, on the porous oxide particles, Pd may be supported along with Pt, and Rh may also be supported as long as it is in an amount up to 10% of the weight of Pt.

Rh has poor compatibility with the NOx storage material. If Rh coexists with the NOx storage material, the properties of the NOx storage material and Rh are not sufficiently exhibited. Further, the steam reforming activity of Rh is decreased by the NOx storage material. Thus, in the case of the NOx storage reduction type catalyst, it is preferred that the NOx storage material be supported along with a noble metal, such as Pt, on the porous oxide particles. In actuality, the second porous oxide particles are used to support the Pt or NOx storage material thereon. Further, the amount of NOx storage material on the second porous oxide particles is preferably set to 50% or more, and more preferably 70% or more, as computed based on the total quantity of the catalyst. Thereby, the NOx storage capability is maximally exhibited, and also, adverse effects on Rh by the NOx storage material may be avoided.

The NOx storage material includes at least one element selected from among alkali metals and alkali earth metals. Examples of the alkali metals used include lithium (Li), sodium (Na), potassium (K), and cesium (Cs). Examples of the alkali earth metals used include magnesium (Mg), calcium (Ca), strontium (Sr), and barium (Ba).

The amount of the NOx storage material that is supported is preferably set to 0.01˜5 mol and more preferably 0.1˜0.5 mol per liter of the catalyst. When the amount of the NOx storage material that is supported is smaller than 0.01 mol, the NOx purification rate becomes decreased. Conversely, when the supported amount exceeds 5 mol, the purification effect reaches saturation levels.

In the case of the three-way catalyst, powder obtained by supporting Rh on the yttria-stabilized zirconia support particles is mixed with powder obtained by supporting the noble metal such as Pt on porous oxide including aluminum oxide, thereby forming a three-way catalyst. In addition, in the case of the NOx storage reduction type catalyst, powder obtained by supporting Rh on the yttria-stabilized zirconia support particles is mixed with powder obtained by supporting the noble metal such as Pt and the NOx storage material on porous oxide including aluminum oxide, thereby forming a NOx storage reduction type catalyst.

In the respective catalysts, the amounts of the two types of powder, which are mixed together, are not particularly limited, and are determined depending on the amount of noble metal or NOx storage material which is supported.

The exhaust gas purifying catalyst according to the present invention may be provided in the form of a pellet catalyst using the mixed catalyst powder, or alternatively, of a monolithic catalyst comprising a heat-resistant honeycomb substrate and a catalyst powder coating layer formed thereon.

### EXAMPLES

The present invention is described in detail through the following test examples, examples, and comparative examples.

### Test Example 1

In the case of an actual exhaust gas purifying catalyst, because functions of various catalytic metals are combined, only the performance of Rh is difficult to evaluate. Herein, a sample composed of Rh and a support was prepared, and the high-temperature durability of Rh was evaluated.

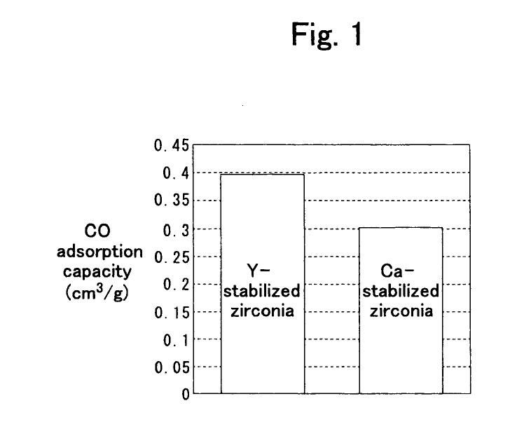

Y-stabilized zirconia powder containing 6 mol % of yttria was prepared, impregnated with a predetermined amount of aqueous rhodium acetate solution having a predetermined concentration, dried at 250° C., and then burned at 500° C., thus obtaining Rh/Y—ZrO₂ powder having 1 mass % of Rh supported thereon. The Rh/Y—ZrO₂ powder was subjected to a durability test in air at 750° C. for 5 hours. After the durability test, CO was adsorbed on the Rh/Y—ZrO₂ powder using a CO chemisorption process, thus measuring the CO adsorption capacity of the Rh/Y—ZrO₂ powder per unit weight. The results are shown in FIG. 1.

In addition, Ca-stabilized zirconia powder containing 4 mol % of calcium was prepared, impregnated with Rh as above, and then subjected to the same durability test. After the durability test, the CO adsorption capacity of the Rh/Ca—ZrO₂ powder per unit weight was measured in the same manner as above. The results are shown in FIG. 1.

As is apparent from FIG. 1, the Rh/Y—ZrO₂ powder, in which Rh was supported on the Y-stabilized zirconia powder, had a CO adsorption capacity greater than that of the Rh/Ca—ZrO₂ powder, wherein Rh was supported on the Ca-stabilized zirconia powder. The CO adsorption capacity indicates the degree of dispersibility of Rh. Hence, in the Rh/Y—ZrO₂ powder in which Rh was supported on the Y-stabilized zirconia powder, the grain growth of Rh upon the durability test was evaluated to be suppressed, as compared to the Rh/Ca—ZrO₂ powder in which Rh was supported on the Ca-stabilized zirconia powder.

### Example 1

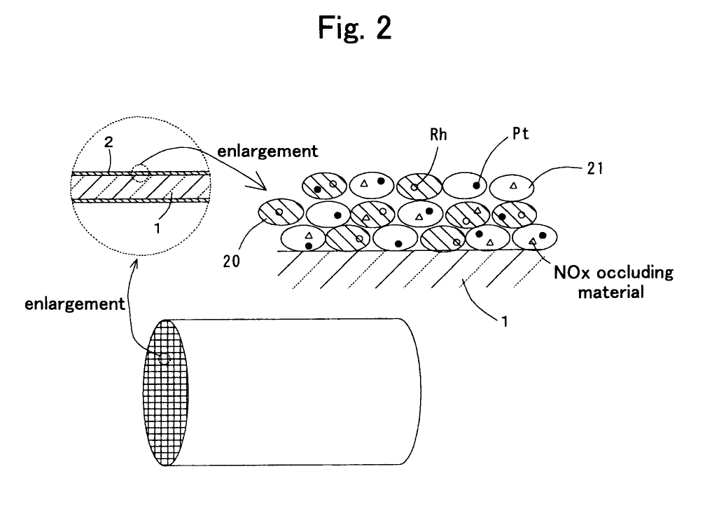

FIG. 2 schematically shows the exhaust gas purifying catalyst according to the present invention. This exhaust gas purifying catalyst is a NOx storage reduction type catalyst, including a honeycomb substrate 1 having a straight flow structure, and a catalyst coating layer 2 formed on the cell walls of the honeycomb substrate 1. The catalyst coating layer 2 was composed of Y-stabilized zirconia particles 20 and porous oxide particles 21 consisting of aluminum oxide powder and cerium oxide-zirconia solid solution powder. As such, the Y-stabilized zirconia particles 20 had Rh and a NOx storage material supported thereon, and the porous oxide particles 21 had Pt and a NOx storage material supported thereon.

50 parts by mass of Rh/Y—ZrO₂ powder in which Rh was supported on the Y-stabilized zirconia powder prepared in Test Example 1 was mixed with 150 parts by mass of aluminum oxide powder, 20 parts by mass of cerium oxide-zirconia solid solution powder, 100 parts by mass of aluminum oxide sol as a binder, and water, thus preparing a slurry.

Further, a cordierite honeycomb substrate (volume: 2 l, cell density: 400 cells/in², length: 1500 mm) was prepared, wash-coated with the slurry, dried at 250° C., and then burned at 500° C., thus forming a catalyst coating layer 2. The catalyst coating layer 2 was formed in an amount of 220 g per liter of the honeycomb substrate 1, and the amount of Rh supported was 0.5 g per liter of the honeycomb substrate 1.

Thereafter, the honeycomb substrate 1 having the catalyst coating layer 2 was impregnated with a predetermined amount of an aqueous dinitrodiamine platinum acetate solution having a predetermined concentration, dried at 250° C., and then burned at 500° C., thus supporting Pt on the catalyst coating layer 2. The amount of Pt supported was 2.0 g per liter of the honeycomb substrate.

Further, the honeycomb substrate 1 having the catalyst coating layer 2 was impregnated with a predetermined amount of an aqueous solution mixture of barium acetate and potassium acetate, dried at 250° C., and then burned at 500° C., thus supporting Ba and K on the catalyst coating layer 2. The amounts of Ba and K that were supported were 0.3 mol and 0.1 mol per liter of the honeycomb substrate, respectively.

### Example 2

Rh/Y—ZrO₂ powder was prepared in the same manner as in Test Example 1, with the exception that, as the Y-stabilized zirconia particles 20, Y-stabilized zirconia containing 3 mol % of yttria was used. Subsequently, a NOx storage reduction type catalyst was prepared as in Example 1 using the Rh/Y—ZrO₂ powder.

### Example 3

Rh/Y—ZrO₂ powder was prepared in the same manner as in Test Example 1, with the exception that, as the Y-stabilized zirconia particles 20, Y-stabilized zirconia containing 9 mol % of yttria was used. Subsequently, a NOx storage reduction type catalyst was prepared as in Example 1 using the Rh/Y—ZrO₂ powder.

### Comparative Example 1

Rh/Ca—ZrO₂ powder was prepared in the same manner as in Test Example 1, with the exception that Ca-stabilized zirconia particles containing 4 mol % of Ca were used, instead of the Y-stabilized zirconia particles 20. Subsequently, a NOx storage reduction type catalyst was prepared as in Example 1 using the Rh/Ca—ZrO₂ powder.

### Comparative Example 2

Rh/Y—ZrO₂ powder was prepared in the same manner as in Test Example 1, with the exception that, as the Y-stabilized zirconia particles 20, Y-stabilized zirconia containing 1 mol % of yttria was used. Subsequently, a NOx storage reduction type catalyst was prepared as in Example 1 using the Rh/Y—ZrO₂ powder.

### Comparative Example 3

Rh/Y—ZrO₂ powder was prepared in the same manner as in Test Example 1, with the exception that, as the Y-stabilized zirconia particles 20, Y-stabilized zirconia containing 9.5 mol % of yttria was used. Subsequently, a NOx storage reduction type catalyst was prepared as in Example 1 using the Rh/Y—ZrO₂ powder.

### Test Example 2

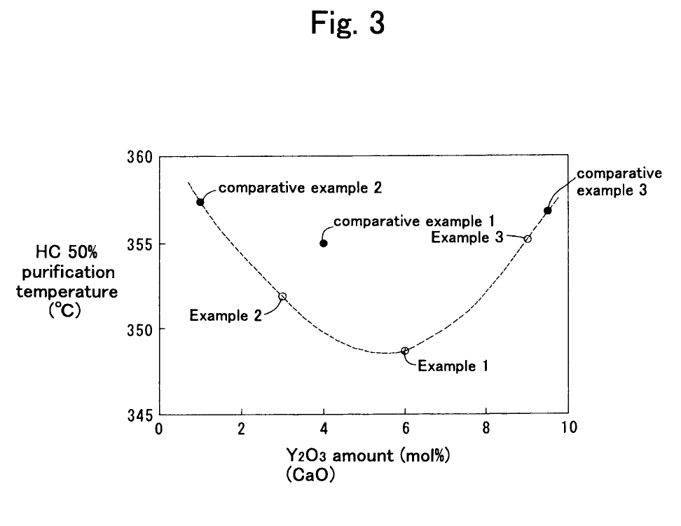

Each of the above catalysts was mounted in a 2.0 l lean-burn engine exhaust system, and then subjected to a durability test corresponding to an engine being run for the equivalent of 60,000 km. After the durability test, the HC 50% purification temperature of each catalyst in a stoichiometric atmosphere using the same exhaust system was measured. The results are plotted in FIG. 3.

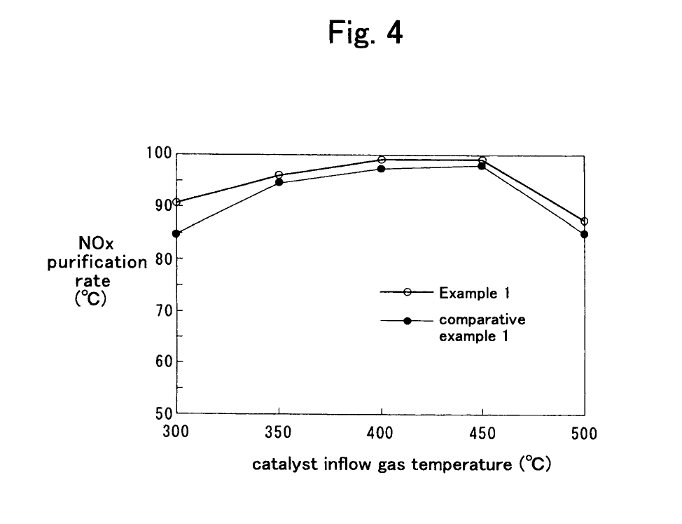

Further, in the catalysts of Example 1 and Comparative Example 1, the catalyst inflow gas temperature and the NOx purification rate in alternating lean/rich atmospheres (60 sec/3 sec, respectively) were measured. The results are plotted in FIG. 4.

As shown in FIG. 3, the catalyst of the examples could purify HC even at lower temperatures, compared to the catalyst of Comparative Example 1, and also exhibited superior durability. This is considered to be due to the use of the Rh/Y—ZrO₂ powder. As is apparent from the results of Comparative Examples 1˜3 and Examples 1˜3, the amount of yttria in the Y-stabilized zirconia is preferably set at 2˜9 mol %, more preferably at 3˜8 mol %, and still more preferably at 4˜6 mol %.

Although the initial HC and NOx purification performance of the catalyst of Example 1 was equal to that of the catalyst of Comparative Example 1, as shown in FIG. 4, the catalyst of Example 1 exhibited higher durability for NOx purification performance, compared to the catalyst of Comparative Example 1. Consequently, the use of Rh/Y—ZrO₂ powder can enhance the durability more than when using Rh/Ca—ZrO₂ powder, and also, can suppress the deterioration of Rh.

While the invention has been shown and described with reference to preferred embodiments thereof, it will be understood by those skilled in the art that various changes and modification may be made without departing from the spirit and scope of the invention as defined in the following claims.

1. (canceled)

2. (canceled)

3. An exhaust gas purifying catalyst, comprising Rh/Y—ZrO₂ particles obtained by supporting rhodium on zirconia support particles containing 2˜9 mol % of yttria and particles obtained by supporting a noble metal and a NOx storage material on porous oxide particles.

4. The catalyst according to claim 3, wherein the yttria is contained in an amount of 3˜8 mol % in the support particles.
